(19) United States
(12) Patent Application Publication
(10) Pub. No.: US 2026/0234744 A1
(43) Pub. Date: Aug. 13, 2026

(54) METHOD FOR MANUFACTURING GRAIN-ORIENTED ELECTRICAL STEEL SHEET AND MANUFACTURING APPARATUS OF GRAIN-ORIENTED ELECTRICAL STEEL SHEET

(71) Applicant: NIPPON STEEL CORPORATION, Tokyo (JP)

(72) Inventors: Hideyuki HAMAMURA, Tokyo (JP); Masato YASUDA, Tokyo (JP); Kimihiko SUGIYAMA, Tokyo (JP)

(73) Assignee: NIPPON STEEL CORPORATION, Tokyo (JP)

(21) Appl. No.: 19/154,130

(22) PCT Filed: Feb. 8, 2024
(86) PCT No.: PCT/JP2024/004394

§ 371 Date: Aug. 6, 2025

(30) Foreign Application Priority Data
Feb. 9, 2023 (JP) 2023-018528

(51) Int. Cl. C21D 10/00; C21D 6/00; C21D 8/1216; C21D 8/1244; C21D 8/1277; C22C 38/00; C22C 38/02; C22C 38/04; C22C 38/06

(52) U.S. Cl. CPC C21D 10/00; C21D 6/008; C21D 8/1222; C21D 8/1233; C21D 8/1255; C21D 8/1272; C21D 8/1283; C22C 38/001; C22C 38/002; C22C 38/02; C22C 38/04; C22C 38/06

(57) ABSTRACT

The present method for manufacturing a grain-oriented electrical steel sheet includes: an oil removal step of removing an oil adhered to a surface of a cold-rolled steel sheet during rolling; a laser irradiation step of irradiating the surface of the cold-rolled steel sheet from which the oil is removed, with a laser beam to form a groove after the oil removal step; and a decarburization annealing step of decarburization-annealing the cold-rolled steel sheet on which the groove is formed, after the laser irradiation step.

### TECHNICAL FIELD

The present invention relates to a method for manufacturing a grain-oriented electrical steel sheet and a manufacturing apparatus of a grain-oriented electrical steel sheet.

Priority is claimed on Japanese Patent Application No. 2023-018528, filed Feb. 9, 2023, the content of which is incorporated herein by reference.

### BACKGROUND ART

There is a method for manufacturing a grain-oriented electrical steel sheet in which a surface of a grain-oriented electrical steel sheet is irradiated with a laser beam to form a groove and thus the magnetic domain of the grain-oriented electrical steel sheet is refined to improve the iron loss (see, for example, Patent Document 1).

### CITATION LIST

### Patent Document

Patent Document 1: Published Japanese Translation No. 2019-512047 of the PCT International Publication

### SUMMARY OF INVENTION

### Technical Problem

Patent Document 1 above describes problems one of which is prevention of a groove depth deviation caused by a change in focal distance of the laser beam. As a method that can solve the problem, a magnetic domain refinement method for a grain-oriented electrical steel sheet is adopted. The magnetic domain refinement method includes: a steel sheet supporting roll position adjusting step of controlling a vertical direction position of a steel sheet while supporting the steel sheet moving along a production line; and a laser emitting step of melting the steel sheet by emitting a laser beam onto the steel sheet to form a groove on a surface of the steel sheet, and the laser emitting step includes: an angle changing step of changing an irradiation line angle by the laser beam with respect to a width direction of the steel sheet while an optical system emitting the laser beam onto the steel sheet is rotated with respect to the steel sheet; and a focal distance maintaining step of changing an inclination of a steel sheet supporting roll that supports the steel sheet according to a change in focal distance of the laser beam in the width direction of the steel sheet.

It is described that according to this magnetic domain refinement method, the quality of the groove can be improved because the groove depth deviation is reduced, in the entire irradiation line formed on the steel sheet by the laser beam, by controlling the inclination of the steel sheet supporting roll according to the change in focal distance of the laser beam and thus the groove can be formed to have a uniform depth.

However, although the variation in the groove depth can be roughly reduced by controlling the inclination of the steel sheet supporting roll, the control is required to be extensive, and further reduction in the variation is difficult. Due to such a background, there has been a demand for a method or an apparatus that can reduce a variation in groove depth in higher order without requiring extensive control.

The present invention has been made in view of the above circumstances, and an object of the present invention is to provide a method for manufacturing a grain-oriented electrical steel sheet and a manufacturing apparatus of a grain-oriented electrical steel sheet such that a variation in groove depth can be reduced in high order in a technique of forming a groove by irradiating a surface of a grain-oriented electrical steel sheet with a laser beam to refine the magnetic domain without requiring extensive control.

### Solution to Problem

In order to solve the above problem and achieve the object, the present invention adopts the following aspects.

A method for manufacturing a grain-oriented electrical steel sheet according to a first aspect of the present invention includes:
an oil removal step of removing an oil adhered to a surface of a cold-rolled steel sheet during rolling;
a laser irradiation step of irradiating the surface of the cold-rolled steel sheet from which the oil is removed, with a laser beam to form a groove after the oil removal step; and a decarburization annealing step of decarburization-annealing the cold-rolled steel sheet on which the groove is formed, after the laser irradiation step.

According to the above aspect, the oil adhered to the surface of the cold-rolled steel sheet during rolling is removed using, for example, the oil removal device, and then the surface of the cold-rolled steel sheet from which the oil is removed is irradiated with the laser beam to form the groove using, for example, a laser irradiation device. Thus, in the present aspect, the variation in the depth of the groove is more suppressed than in a case where a surface of a cold-rolled steel sheet to which oil is still adhered is irradiated with a laser beam to form a groove. Therefore, deterioration of the magnetic characteristics, such as the iron loss, of the grain-oriented electrical steel sheet is suppressed. In addition, extensive control is unnecessary such as conventional inclination control of a steel sheet supporting roll.

Furthermore, in the present aspect, the frequency of cleaning or replacement of an optical component or the like due to contamination is lower than in a case where a surface of a cold-rolled steel sheet to which oil is adhered is irradiated with a laser beam to form a groove.

A method for manufacturing a grain-oriented electrical steel sheet according to a second aspect of the present invention is that the method for manufacturing a grain-oriented electrical steel sheet according to the first aspect may further include a polishing step of removing an adhering substance adhered to the surface of the cold-rolled steel sheet on which the groove is formed, by polishing after the laser irradiation step and before the decarburization annealing step.

In the case of the above aspect, before decarburization annealing by a decarburization annealing device, the adhering substance adhered to the surface of the cold-rolled steel sheet on which the groove is formed is removed by polishing using, for example, a polishing device.

While a surface of a cold-rolled steel sheet is irradiated with a laser beam, a pass line variation may be caused by steel sheet vibration due to the accuracy of tension control or the shape of the steel sheet. As a result, an adhering substance such as a melt projection or a scattered substance may adhere to the surface. In a case where such a possibility is expected, the adhering substance can be removed by polishing. The polishing smooths the surface of the cold-rolled steel sheet. Therefore, deterioration of the magnetic characteristics, such as the iron loss, of the grain-oriented electrical steel sheet is suppressed.

A method for manufacturing a grain-oriented electrical steel sheet according to a third aspect of the present invention is that, in the method for manufacturing a grain-oriented electrical steel sheet according to the first or the second aspect, during the oil removal step, the oil adhered to the surface of the cold-rolled steel sheet may be removed using an oil removal device including a cleaning brush.

In the case of the above aspect, the oil removal device includes the cleaning brush configured to remove the oil adhered to the surface of the cold-rolled steel sheet. Therefore, the oil adhered to the surface of the cold-rolled steel sheet can be efficiently removed by the cleaning brush.

A manufacturing apparatus of a grain-oriented electrical steel sheet according to a fourth aspect of the present invention includes:
an oil removal device configured to remove an oil adhered to a surface of a cold-rolled steel sheet during rolling;
a laser irradiation device configured to irradiate the surface of the cold-rolled steel sheet from which the oil is removed, with a laser beam to form a groove; and a decarburization annealing device configured to decarburization-anneal the cold-rolled steel sheet on which the groove is formed.

According to the above aspect, the oil removal device removes the oil adhered to the surface of the cold-rolled steel sheet during rolling. The laser irradiation device irradiates the surface of the cold-rolled steel sheet from which the oil is removed, with the laser beam to form a groove. Thus, in the present aspect, the variation in the depth of the groove is more suppressed than in a case where a surface of a cold-rolled steel sheet to which oil is still adhered is irradiated with a laser beam to form a groove.

Therefore, deterioration of the magnetic characteristics, such as the iron loss, of the grain-oriented electrical steel sheet is suppressed. In addition, extensive control is unnecessary such as conventional inclination control of a steel sheet supporting roll.

Furthermore, in the present aspect, the frequency of cleaning or replacement of an optical component or the like due to contamination is lower than in a case where a surface of a cold-rolled steel sheet to which oil is adhered is irradiated with a laser beam to form a groove.

A manufacturing apparatus of a grain-oriented electrical steel sheet according to a fifth aspect of the present invention is that the manufacturing apparatus of a grain-oriented electrical steel sheet according to the fourth aspect may further include a polishing device configured to remove an adhering substance adhered to the surface of the cold-rolled steel sheet on which the groove is formed, by polishing before decarburization annealing by the decarburization annealing device.

According to the above aspect, the polishing device removes the adhering substance adhered to the surface of the cold-rolled steel sheet on which the groove is formed, by polishing before decarburization annealing by the decarburization annealing device.

While a surface of a cold-rolled steel sheet is irradiated with a laser beam, a pass line variation may be caused by steel sheet vibration due to the accuracy of tension control or the shape of the steel sheet. As a result, an adhering substance such as a melt projection or a scattered substance may adhere to the surface. In a case where such a possibility is expected, the adhering substance can be removed by polishing. The polishing smooths the surface of the cold-rolled steel sheet. Therefore, deterioration of the magnetic characteristics, such as the iron loss, of the grain-oriented electrical steel sheet is suppressed.

A manufacturing apparatus of a grain-oriented electrical steel sheet according to a sixth aspect of the present invention is that the manufacturing apparatus of a grain-oriented electrical steel sheet according to the fourth or the fifth aspect may include the oil removal device including a cleaning brush configured to remove the oil adhered to the surface of the cold-rolled steel sheet.

According to the above aspect, the oil removal device includes the cleaning brush. The cleaning brush removes the oil adhered to the surface of the cold-rolled steel sheet, and thus the oil adhered to the surface of the cold-rolled steel sheet can be efficiently removed.

### Advantageous Effects of Invention

According to each of the above aspects of the present invention, it is possible to provide a method for manufacturing a grain-oriented electrical steel sheet and a manufacturing apparatus of a grain-oriented electrical steel sheet that can reduce a variation in groove depth in high order without requiring extensive control. In addition, according to each of the above aspects, it is also possible to reduce the frequency of cleaning or replacement of an optical component or the like due to contamination.

### BRIEF DESCRIPTION OF DRAWINGS

FIG. 1 A side view of a manufacturing apparatus of a grain-oriented electrical steel sheet according to an embodiment of the present invention viewed from the width direction of a cold-rolled steel sheet.

FIG. 2 A side view of the manufacturing apparatus of a grain-oriented electrical steel sheet viewed from the width direction of a cold-rolled steel sheet.

FIG. 3 A table showing the depths of grooves on a grain-oriented electrical steel sheet manufactured with a method for manufacturing a grain-oriented electrical steel sheet according to an invention example. That is, the horizontal axis indicates the position in the grain-oriented electrical steel sheet in the sheet width direction, the vertical axis indicates the position in the grain-oriented electrical steel sheet in the rolling direction, and the numerical value in each grid indicates the depth of the groove (unit: μm).

FIG. 4 A table showing the depths of grooves on a grain-oriented electrical steel sheet manufactured with a method for manufacturing a grain-oriented electrical steel sheet according to a comparative example. That is, the horizontal axis indicates the position in the grain-oriented electrical steel sheet in the sheet width direction, the vertical axis indicates the position in the grain-oriented electrical steel sheet in the rolling direction, and the numerical value in each grid indicates the depth of the groove (unit: μm).

FIG. 5 A graph showing the iron loss improvement percentages and the variation in iron loss improvement percentage of grain-oriented electrical steel sheets manufactured with a method for manufacturing a grain-oriented electrical steel sheet according to an invention example.

FIG. 6 A graph showing the iron loss improvement percentages and the variation in iron loss improvement percentage of grain-oriented electrical steel sheets manufactured with a method for manufacturing a grain-oriented electrical steel sheet according to a comparative example.

FIG. 7 A graph showing a relationship between the thickness of oil adhered to a surface of a cold-rolled steel sheet and the depth of a groove formed on the surface of the cold-rolled steel sheet by a laser beam. That is, the horizontal axis represents the thickness (unit: μm) of oil, and the vertical axis represents the depth (unit: μm) of a groove.

### DESCRIPTION OF EMBODIMENTS

As a result of intensive studies by the present inventors on a factor that causes a variation in groove depth, it has been found that the oil (rolling oil) adhered to a surface of a steel sheet has a large effect. That is, in a process of manufacturing a grain-oriented electrical steel sheet, at the time of cold rolling, a rolling oil is applied to at least one of a rolling roll of a rolling mill or a cold-rolled steel sheet before rolling in order to reduce the friction between the rolling roll and the cold-rolled steel sheet, Therefore, oil is formed on a surface of the cold-rolled steel sheet by the rolling oil during rolling.

The present inventors have paid attention to the fact that the groove depth tends to vary in a case where a surface of a cold-rolled steel sheet on which such oil is formed is irradiated with a laser beam to form a groove. Such a variation in groove depth causes deterioration of the magnetic characteristics, such as the iron loss, of the grain-oriented electrical steel sheet. In addition, the oil on a surface of a steel sheet may scatter during sheet passing, and may contaminate an optical component of a peripheral device, such as a laser irradiation device that performs grooving. If such contamination of an optical component is left as it is, the contamination may affect the control of irradiation with a laser beam and may affect the variation in groove depth.

As described above, in manufacture of a grain-oriented electrical steel sheet, oil formation on a steel sheet surface is unavoidable due to cold rolling performed with a rolling mill. Therefore, improvement in the apparatus and the methods has been made on the assumption that oil is present. However, as a result of studies by the present inventors, it has been newly found that oil greatly affects the variation in the depth of a groove, and the present technology has been achieved in which oil is removed at a limited timing after cold rolling and before laser grooving.

Hereinafter, one embodiment and various modification examples of the present invention will be described with reference to the drawings.

### (Grain-Oriented Electrical Steel Sheet)

First, the configuration of a grain-oriented electrical steel sheet according to the present embodiment will be described.

The grain-oriented electrical steel sheet is an electrical steel sheet in which the magnetization easy axes of grains (<100> direction of a body-centered cubic crystal) are substantially aligned in the rolling direction (longitudinal direction, conveyance direction) of the steel sheet. The grain-oriented electrical steel sheet has a plurality of magnetic domains in which magnetization directions are aligned in the rolling direction.

The grain-oriented electrical steel sheet characteristically has a smaller iron loss due to its characteristic magnetic domain configuration than an ordinary steel sheet, and a surface of the grain-oriented electrical steel sheet is irradiated with a laser beam to form a plurality of grooves in order to further reduce the iron loss. The plurality of grooves are formed so as to extend in the width direction (direction perpendicular to the rolling direction) of the grain-oriented electrical steel sheet or in a direction slightly inclined from the width direction, and are formed so as to be arranged at regular intervals in the rolling direction. These grooves refine the magnetic domains of the grain-oriented electrical steel sheet, and improve the iron loss of the grain-oriented electrical steel sheet.

The grain-oriented electrical steel sheet has a property of being easily magnetized in the rolling direction of the grain-oriented electrical steel sheet, and therefore is used as a material of a wound core (core material) of a winding transformer in which lines of magnetic force flow in a substantially constant direction. A wound core is formed, for example, by stacking a plurality of grain-oriented electrical steel sheets and bending (winding) the stacked grain-oriented electrical steel sheets into a core shape.

At the time of forming a groove in the grain-oriented electrical steel sheet, the groove is desirably formed so as to extend in the width direction of the grain-oriented electrical steel sheet because the efficiency of improving the iron loss can be enhanced.

However, for example, in the case of forming the grain-oriented electrical steel sheet into a wound core of a transformer, when the grain-oriented electrical steel sheet is folded at a folding line along the width direction after groove formation, the grain-oriented electrical steel sheet is more likely to fracture from a formed groove. If a groove is formed so as to extend in a direction slightly inclined from the width direction of the grain-oriented electrical steel sheet, the efficiency of improving the iron loss slightly deteriorates, but the possibility of fracture at the time of folding can be reduced. In the case of forming a groove extending in a direction slightly inclined from the width direction of the grain-oriented electrical steel sheet, the angle of inclination can be appropriately set, and in consideration of the efficiency of improving the iron loss and the possibility of fracture; the groove is preferably inclined at an angle of, for example, more than 0° and 20° or less.

The grain-oriented electrical steel sheet is constituted of an iron alloy containing

Si. The grain-oriented electrical steel sheet has a composition of, for example, Si: 2.5 mass % or more and 4.0 mass % or less, C: 0.001 mass % or more and 0.10 mass % or less; Mn: 0.05 mass % or more and 0.20 mass % or less, acid-soluble Al: 0.001 mass % or more and 0.040 mass % or less, N: 0.0002 mass % or more and 0.012 mass % or less, S: 0.0001 mass % or more and 0.030 mass % or less, P: 0.01 mass % or more and 0.04 mass % or less, and the balance being Fe and an inevitable impurity. The grain-oriented electrical steel sheet has a thickness of, for example, 0.15 mm or more and 0.35 mm or less. [003.1]

The surface of the grain-oriented electrical steel sheet is coated with a glass coating. The glass coating is constituted of, for example, a composite oxide such as forsterite (Mg₂SiO₄), spinel (MgAl₂O₄), or cordierite (Mg₂Al₄Si₅O₁₈). The glass coating has a thickness of, for example, 1 μm.

The glass coating is further coated with an insulating coating. The insulating coating is constituted of, for example, an insulating coating agent (coating liquid) mainly containing colloidal silica and a phosphate (such as magnesium phosphate or aluminum phosphate), or an insulating coating agent (coating liquid) obtained by mixing alumina sol and boric acid.

### (Manufacturing Apparatus of Grain-Oriented Electrical Steel Sheet)

Next, the configuration of a manufacturing apparatus of a grain-oriented electrical steel sheet according to the present embodiment will be described.

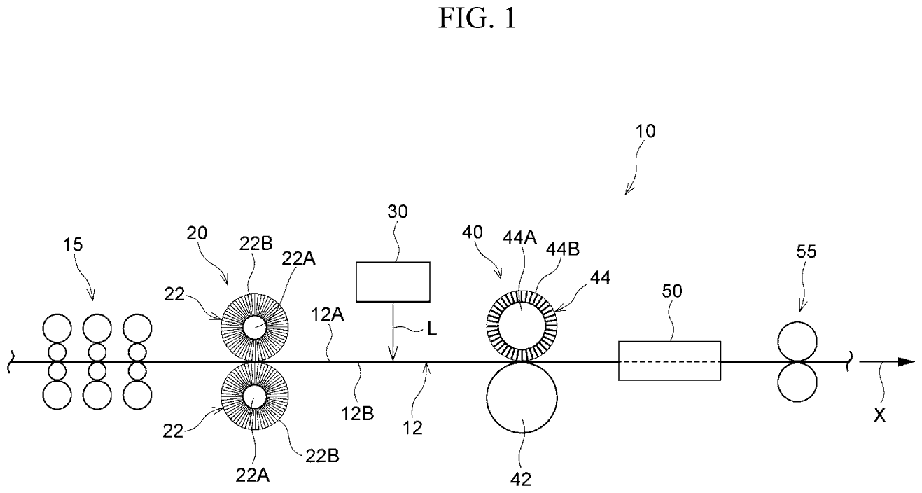

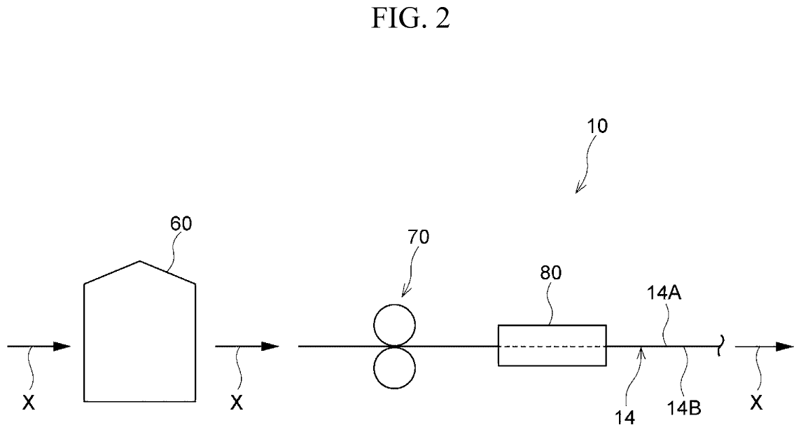

FIGS. 1 and 2 show a side view of a manufacturing apparatus 10 of a grain-oriented electrical steel sheet according to the present embodiment viewed from the width direction of a cold-rolled steel sheet 12. The manufacturing apparatus 10 of a grain-oriented electrical steel sheet is an apparatus for manufacture of a grain-oriented electrical steel sheet 14 (see FIG. 2). FIGS. 1 and 2 are continuous as a manufacturing line of the manufacturing apparatus 10, and a hot-rolled steel sheet that is a material of the grain-oriented electrical steel sheet 14 is treated with each device included in the manufacturing apparatus 10 shown in FIG. 1, and then further treated with each device included in the manufacturing apparatus 10 shown in FIG. 2, and thus the grain-oriented electrical steel sheet 14 with improved iron loss is obtained.

In an example, the manufacturing apparatus 10 includes a finish rolling mill 15, oil removal device 20, a laser irradiation device 30, a polishing device 40, a decarburization annealing device 50, an annealing separator applying device 55, a final annealing device 60, an insulating coating agent coating device 70, and a flattening annealing device 80. The finish rolling mill 15, the oil removal device 20, the laser irradiation device 30, the polishing device 40, the decarburization annealing device 50, the annealing separator applying device 55, the final annealing device 60, the insulating coating agent coating device 70, and the flattening annealing device 80 are disposed in this order along the manufacturing line of the grain-oriented electrical steel sheet 14 (see. FIG. 2) in the conveyance direction (rolling direction, arrow X direction) of the grain-oriented electrical steel sheet 14.

### (Finish Rolling Mill)

As shown in FIG. 1, the finish rolling mill 15 rolls (cold-rolls) a hot-rolled steel sheet that is a material of the grain-oriented electrical steel sheet 14 (see FIG. 2) so as to obtain a desired sheet thickness, and thus generates the cold-rolled steel sheet 12. As the finish rolling mill 15 according to the present embodiment, a known finish rolling mill can be appropriately applied.

### (Oil Removal Device)

The oil removal device 20 is a device, for the cold-rolled steel sheet 12 generated by the finish rolling mill 15, configured to remove oil adhered to surfaces 12A and 12B on both sides of the cold-rolled steel sheet 12 during rolling. The oil removal device 20 is provided downstream of the finish rolling mill 15 in the conveyance direction (arrow X direction) of the cold-rolled steel sheet 12.

As described above, at the time of cold rolling, an oil (rolling oil) is applied to at least one of a rolling roll of the finish rolling mill 15 or the cold-rolled steel sheet 12 before rolling in order to reduce the friction between the rolling roll and the cold-rolled steel sheet 12. Therefore, the rolling oil is adhered to the surfaces 12A and 12B of the cold-rolled steel sheet 12 immediately after rolling, and spreads as oil. The oil removal device 20 removes such oil caused by a rolling oil.

The oil removal device 20 is disposed at a position downstream of the finish rolling mill 15 and upstream of the laser irradiation device 30 in the sheet passing direction. The oil removal device 20 includes a pair of cleaning brush rolls 22. The pair of cleaning brush rolls 22 are disposed on both sides (the surface 12A side as a front side and the surface 12B side as a back side), respectively, in the thickness direction of the cold-rolled steel sheet 12.

Each cleaning brush roll 22 includes a roll 22A and a cleaning brush 22B. The roll 22A is disposed so that the direction of its rotary shaft is parallel to the width direction of the cold-rolled steel sheet 12. Both ends of the roll 22A in the shaft direction are rotatably supported by bearings (not shown), respectively, and the roll 22A (that is, the cleaning brush roll 22) is rotationally driven by a motor or the like (not shown). The rotation direction of the cleaning brush roll 22 is not particularly limited, but the rotation direction is preferably relatively opposite to the conveyance direction of the cold-rolled steel sheet 12 because cleaning can be efficiently performed. That is, in FIG. 1, the right direction on the paper surface is the sheet passing direction, and therefore the upper cleaning brush roll 22 disposed to face the surface 12A preferably rotates clockwise about the axis perpendicular to the paper surface. Meanwhile, the lower cleaning brush roll 22 disposed to face the surface 12B preferably rotates counterclockwise about the axis perpendicular to the paper surface. In this case, the pair of upper and lower cleaning brush rolls 22 rotate in directions opposite to each other and in the direction opposite to the traveling direction of the surfaces 12A and 12B (sheet passing direction) to receive and simultaneously scrape off approaching oil on the surfaces 12A and 12B, and thus the oil can be efficiently removed.

The cleaning brush 22B is configured to radially extend from the roll 22A in the radial direction, and is disposed so that the end of the cleaning brush 22B is in contact with the surface 12A or 12B of the cold-rolled steel sheet 12 so as to remove oil. The cleaning brush 22B is formed using a bristle, such as nylon, softer than a polishing brush 44B described below so as not to cause damage, such as a defect, to the surfaces 12A and 12B of the cold-rolled steel sheet 12. The cleaning brush 22B is supplied with a cleaning agent capable of removing oil, from a cleaning liquid supply nozzle (not shown). As the cleaning agent, for example, an alkaline cleaning agent is used. Thus, the oil removal device 20 can sequentially rub the tips of the bristles of the cleaning brush 22B against the surfaces 12A and 12B of the cold-rolled steel sheet 12 in accordance with rotation of the roll 22A, and can scrape off oil spreading on the surfaces 12A and 12B of the cold-rolled steel sheet 12 while appropriately using the cleaning agent.

The above description is made with reference to an example in which the direction of the rotary shaft of the cleaning brush roll 22 is parallel to the width direction of the cold-rolled steel sheet 12 in both of a case where the scanning direction of a laser beam L by the laser irradiation device 30 described below is parallel to the width direction of the cold-rolled steel sheet 12 and a case where the scanning direction is inclined by a predetermined angle from the width direction of the cold-rolled steel sheet 12. However, if meandering of the cold-rolled steel sheet 12 can be suppressed by, for example, adjusting the conveyance speed and the like, in a case where the scanning direction is inclined by a predetermined angle from the width direction of the cold-rolled steel sheet 12, the direction of the rotary shaft of the cleaning brush roll 22 may also be inclined by an angle within a range from the direction parallel to the width direction of the cold-rolled steel sheet 12 to the predetermined angle.

As described below, a configuration may be adopted in which a cleaning tank or an ultrasonic cleaning tank (not shown) is adopted instead of the cleaning brush roll 22 and thus oil on the cold-rolled steel sheet 12 is removed.

Although not shown in FIG. 1, a device such as a dryer, a drying machine, or an air knife may be applied for the purpose of removing moisture on the surfaces 12A and 12B of the cold-rolled steel sheet 12 after oil removal.

### (Laser Irradiation Device)

The laser irradiation device 30 is disposed downstream of the oil removal device, in the conveyance direction (arrow X direction) of the cold-rolled steel sheet 12. The laser irradiation device 30 irradiates the surface 12A of the cold-rolled steel sheet 12 after removing the oil by the oil removal device 20, with the laser beam L to form a groove.

Specifically, the laser irradiation device 30 irradiates the surface 12A of the cold-rolled steel sheet 12, between the surfaces 12A and 12B of the cold-rolled steel sheet 12, with the laser beam L, scans the surface 12A with the laser beam L, and thus forms a groove extending in the direction parallel to the width direction of the cold-rolled steel sheet 12 or in a direction inclined by a predetermined angle (preferably, an angle more than 0° and 20° or less) from the width direction of the cold-rolled steel sheet 12 (hereinafter, these directions may be referred to as “scanning direction” or “groove extending direction”), on the surface 12A of the cold-rolled steel sheet 12.

The laser irradiation device 30 forms a plurality of grooves extending in the scanning direction at a predetermined pitch in the rolling direction (arrow X direction) of the cold-rolled steel sheet 12. These grooves refine the magnetic domains of the grain-oriented electrical steel sheet 14 (see FIG. 2) to improve the iron loss of the grain-oriented electrical steel sheet 14.

The type of the laser beam is, for example, a fiber laser, a YAG laser, or a CO2 laser. The wavelength of the laser beam L can be selected from, for example, a range of 150 nm to 11 μm (11000 nm). Here, in the case of selecting a fiber laser or a YAG laser as the type of the laser beam L, the wavelength of the laser beam L can be selected from a range of 1060 nm to 1090 nm. Alternatively, in the case of selecting a CO2 laser as the type of the laser beam L, the wavelength of the laser beam L can be selected to be 10.6 μm (10600 nm). The depth of each groove is, for example, 20 μm. The width of the groove is, for example, 50 μm. The interval (pitch) between the grooves is, for example, 3 mm.

### (Polishing Device)

The polishing device 40 is disposed downstream of the laser irradiation device in the conveyance direction (arrow X direction) of the cold-rolled steel sheet 12.

After irradiation with the laser beam L by the laser irradiation device 30 and before decarburization annealing by the decarburization annealing device 50 described below, the polishing device 40 polishes or grinds and removes an adhering substance, such as a melt projection or a scattered substance, adhered to the surface 12A of the cold-rolled steel sheet 12 on which the groove is formed.

The polishing device 40 includes a pair of a backup roll 42 and a polishing brush roll 44. The backup roll 42 is disposed so that the direction of its rotary shaft is parallel to the width direction of the cold-rolled steel sheet 12. That is, in FIG. 1, the right direction on the paper surface is the sheet passing direction, and therefore the rotation direction of the backup roll 42 is clockwise about the axis perpendicular to the paper surface. Both ends of the backup roll 42 in the shaft direction are rotatably supported by bearings (not shown), respectively. The backup roll 42 is disposed to face the side of the surface 12B, between the surfaces 12A and 12B of the cold-rolled steel sheet 12, on which no groove is formed, and supports the surface 12B, on which no groove is formed, of the cold-rolled steel sheet 12.

The polishing brush roll 44 is disposed on the side opposite from the backup roll 42 (the side of the surface 12A on which the groove is formed) with respect to the cold-rolled steel sheet 12. The polishing brush roll 44 includes a roll 44A and a polishing brush 44B. The roll 44A is disposed so that the direction of its rotary shaft is parallel to the width direction of the cold-rolled steel sheet 12. Both ends of the roll 44A in the shaft direction are rotatably supported by bearings (not shown), respectively, and the roll 44A (that is, the polishing brush roll 44) is rotationally driven by a motor or the like (not shown). The rotation direction of the polishing brush roll 44 is not particularly limited, but the rotation direction is preferably relatively opposite to the moving direction of the cold-rolled steel sheet 12 because polishing can be efficiently performed. That is, in FIG. 1, the right direction on the paper surface is the sheet passing direction, and therefore the polishing brush roll 44 preferably rotates clockwise about the axis perpendicular to the paper surface. In this case, the polishing brush roll 44 can receive and simultaneously polish or grind and thus remove an approaching adhering substance on the surface 12A, and thus the adhering substance can be efficiently removed.

The polishing brush 44B is configured to radially extend from the roll 44A in the radial direction, is formed using a bristle, such as nylon, harder than the cleaning brush 22B described above or a bristle such as nylon containing abrasive grains, and is disposed so that the tip of the bristle is in contact with the surface 12A of the cold-rolled steel sheet 12. Thus, the polishing device 40 can sequentially rub the tips of the bristles of the polishing brush 44B against the surface 12A of the cold-rolled steel sheet 12 in accordance with rotation of the polishing brush roll 44, and can scrape off an adhering substance such as a projection protruding from the surface 12A of the cold-rolled steel sheet 12.

The above description is made with reference to an example in which the direction of the rotary shaft of the polishing brush roll 44 is parallel to the width direction of the cold-rolled steel sheet 12 in both of a case where the scanning direction is parallel to the width direction of the cold-rolled steel sheet 12 and a case where the scanning direction is inclined in the horizontal direction by a predetermined angle from the width direction of the cold-rolled steel sheet 12. However, if meandering of the cold-rolled steel sheet 12 can be suppressed by, for example, adjusting the conveyance speed, in a case where the scanning direction is inclined by a predetermined angle from the width direction of the cold-rolled steel sheet 12, the direction of the rotary shaft of the polishing brush roll 44 may be inclined by an angle within a range from the direction parallel to the width direction of the cold-rolled steel sheet 12 to the predetermined angle.

Although not shown in FIG. 1, after the polishing brush, a device such as a dryer, a drying machine, or an air knife may be applied for the purpose of removing moisture on the surfaces 12A and 12B of the cold-rolled steel sheet 12.

### (Decarburization Annealing Device)

The decarburization annealing device 50 is disposed downstream of the polishing device 40 in the conveyance direction (arrow X direction) of the cold-rolled steel sheet 12, The decarburization annealing device 50 is a device that decarburization-anneals the cold-rolled steel sheet 12 on which the groove is formed. More specifically, the decarburization annealing device 50 performs decarburization annealing (continuous annealing) on the cold-rolled steel sheet 12 on which the groove is formed, under conditions of a predetermined temperature (for example, 700° C. to 900° C.) and a heating time of 1 minute to 3 minutes.

Here, as a result of decarburization annealing of the cold-rolled steel sheet 12 by the decarburization annealing device 50, the cold-rolled steel sheet 12 is decarburized, and primary recrystallization (grain size: 10 μm to 30 μm) is generated in the cold-rolled steel sheet 12. Furthermore, as a result of decarburization annealing, an oxide layer mainly containing silica (SiO₂) is formed on the surfaces 12A and 12B of the cold-rolled steel sheet 12.

During or after the decarburization annealing, nitridation of the cold-rolled steel sheet 12 is also possible by heat treatment in an ammonia-containing atmosphere (for example, 150 ppm to 300 ppm).

### (Annealing Separator Applying Device)

The annealing separator applying device 55 is disposed downstream of the decarburization annealing device 50 in the conveyance direction (arrow X direction) of the cold-rolled steel sheet 12. The annealing separator applying device 55 applies an annealing separator mainly containing magnesia (MgO) onto the oxide layers formed during decarburization annealing on the surfaces 12A and 12B of the cold-rolled steel sheet 12. Then, the cold-rolled steel sheet 12 to which the annealing separator is applied is wound into a coil shape by a winding device (not shown).

### (Final Annealing Device)

As shown in FIG. 2, the final annealing device 60 is disposed downstream of the annealing separator applying device 55 in the conveyance direction (arrow X direction) of the cold-rolled steel sheet 12. The final annealing device 60 anneals the cold-rolled steel sheet 12 decarburization-annealed by the decarburization annealing device 50 to generate secondary recrystallization. More specifically, the final annealing device 60 inserts the cold-rolled steel sheet 12 after being decarburization-annealed by the decarburization annealing device 50 and to which the annealing separator is applied by the annealing separator applying device 55, into a batch furnace as the cold-rolled steel sheet 12 is in a state of being wound in a coil shape, and performs heat treatment. The heat treatment conditions are, for example, a heating temperature of 1100° C. to 1300° C. and a heating time of 20 hours to 24 hours. At this time, so-called Goss grains in which the rolling direction of the cold-rolled steel sheet 12 and the magnetization easy axis coincide with each other preferentially grow into a crystal (secondary recrystallization is generated). As a result, the grain-oriented electrical steel sheet 14 having a high crystal orientation property (crystal orientation) is obtained after the final annealing. At the time of final annealing, the oxide layer and the annealing separator react with each other to form a glass coating made of forsterite (Mg₂SiO₄) on the surfaces 12A and 12B of the cold-rolled steel sheet 12, and thus the grain-oriented electrical steel sheet 14 is formed.

### (Insulating Coating Agent Coating Device)

The insulating coating agent coating device 70 is disposed downstream of the final annealing device 60 in the conveyance direction (arrow X direction) of the grain-oriented electrical steel sheet 14. The insulating coating agent coating device 70 applies an insulating coating agent (coating liquid) capable of imparting electrical insulation properties and capable of imparting a predetermined tension to the surfaces 14A and 14B, onto the glass coating formed on the surfaces 14A and 14B of the grain-oriented electrical steel sheet 14 in which secondary recrystallization is generated in a state where the grain-oriented electrical steel sheet 14 wound into a coil shape is unwound into a sheet shape and spread.

### (Flattening Annealing Device)

The flattening annealing device 80 is disposed downstream of the insulating coating agent coating device 70 in the conveyance direction (arrow X direction) of the grain-oriented electrical steel sheet 14. The flattening annealing device 80 anneals the grain-oriented electrical steel sheet 14 to which the insulating coating agent is applied, while a conveyor conveys the grain-oriented electrical steel sheet 14, at a predetermined temperature (for example, 800° C. to 850° C.) for a predetermined time (for example, 10 seconds or more and 120 seconds or less) to plate the grain-oriented electrical steel sheet 14 with the insulating coating agent, and thus an insulating coating is formed on the surfaces 14A and 14B of the grain-oriented electrical steel sheet 14. Thus, a tension (sheet passing tension) along the rolling direction (longitudinal direction) of the grain-oriented electrical steel sheet 14 is applied to the grain-oriented electrical steel sheet 14 from the conveyor, and the winding form and the strain applied to the grain-oriented electrical steel sheet 14 during the final annealing are removed to flatter the grain-oriented electrical steel sheet 14. The insulating coating on the surface of the grain-oriented electrical steel sheet 14 imparts electrical insulation properties to the grain-oriented electrical steel sheet 14.

### (Method for Manufacturing Grain-Oriented Electrical Steel Sheet)

Next, an example of a method for manufacturing a grain-oriented electrical steel sheet according to the present embodiment will be described.

In an example, the method for manufacturing a grain-oriented electrical steel sheet according to the present embodiment includes a casting step, a hot rolling step, an annealing step, a cold rolling step, an oil removal step, a laser irradiation step, a polishing step, a decarburization annealing step, an annealing separator applying step, a final annealing step, and an insulating coating agent applying step.

### (Casting Step to Annealing Step)

First, in the casting step (continuous casting step), a slab is formed by a continuous casting machine (not shown). Next, in the hot rolling step, the slab is hot-rolled by a roughing mill or the like (not shown) to form a steel sheet (hereinafter, referred to as “hot-rolled steel sheet”) having a predetermined thickness. Next, in the annealing step, the hot-rolled steel sheet is annealed at a predetermined temperature.

### (Cold Rolling Step)

Next, as shown in FIG. 1, in the cold rolling step, the hot-rolled steel sheet having front and back surfaces on both of which a rolling oil (cold rolling oil) is applied is rolled by the finish rolling mill 15 and thus extended in a predetermined direction (hereinafter, referred to as “rolling direction”) to form a cold-rolled steel sheet 12 having a predetermined thickness. The rolling direction of the cold-rolled steel sheet 12 coincides with the longitudinal direction of the cold-rolled steel sheet 12 (grain-oriented electrical steel sheet 14). The cold-rolled steel sheet 12 after the cold rolling step proceeds to the oil removal step, which is a subsequent step, while oil is formed on the surfaces 12A and 12B.

### (Oil Removal Step)

Next, in the oil removal step, the oil removal device 20 is used to remove the oil adhered to the surfaces 12A and 12B on both sides of the cold-rolled steel sheet 12.

Specifically, the oil removal device 20 is used to rotate the pair of cleaning brush rolls 22 by a motor (not shown) while the pair of cleaning brush rolls 22 are each supplied with a cleaning liquid from a cleaning liquid supply nozzle (not shown). Thus, the oil adhered to the surfaces 12A and 12B on both sides of the cold-rolled steel sheet 12 are scraped off and removed by the rotating cleaning brush 22B. Therefore, the cold-rolled steel sheet 12 after the oil removal step performed by the oil removal device 20 proceeds to the laser irradiation step, which is a subsequent step, after the oil on the surfaces 12A and 12B are completely removed.

### (Laser Irradiation Step)

Next, in the laser irradiation step, the laser irradiation device 30 is used to irradiate the surface 12A of the cold-rolled steel sheet 12 which is conveyed by the conveyor and from which the oil is removed in advance, with the laser beam L to form a plurality of grooves (laser grooves).

Specifically, the laser irradiation device 30 irradiates the surface 12A of the cold-rolled steel sheet 12 conveyed by the conveyor with the laser beam L to form a groove along the direction parallel to the width direction of the cold-rolled steel sheet 12 or a direction inclined by a predetermined angle (preferably, an angle more than 0° and 20° or less) from the width direction of the cold-rolled steel sheet 12 (these directions may be referred to as “scanning direction” or “groove extending direction”) on the surface 12A.

The laser irradiation device 30 forms the plurality of grooves described above on the surface 12A of the cold-rolled steel sheet 12 at predetermined intervals (pitches) in the rolling direction of the cold-rolled steel sheet 12. These grooves refine the magnetic domains of the grain-oriented electrical steel sheet 14, and improve the iron loss of the grain-oriented electrical steel sheet 14. Then, in the cold-rolled steel sheet 12 after the laser irradiation step is performed by the laser irradiation device 30 to form the plurality of grooves, an adhering substance such as a melt projection or a scattered substance is adhered to the surface 12A, and in this state, the cold-rolled steel sheet 12 proceeds to the polishing step, which is a subsequent step. The surface 12B of the cold-rolled steel sheet 12 is not subjected to laser grooving, and therefore an adhering substance is not adhered.

### (Polishing Step)

Next, in the polishing step, the polishing device 40 is used, before decarburization annealing by the decarburization annealing device 50, to remove the adhering substance such as a melt projection or a scattered substance adhered to the surface 12A of the cold-rolled steel sheet 12 on which the groove is formed with the laser beam L.

Specifically, in the polishing device 40, the polishing brush roll 44 is rotated by a motor (not shown) while a polishing liquid containing abrasive grains is supplied from a polishing liquid supply nozzle (not shown) to the surface 12A of the cold-rolled steel sheet 12, or the polishing brush roll 44 including a bristle such as nylon containing abrasive grains is rotated by a motor (not shown) while a polishing liquid containing water is supplied from a polishing liquid supply nozzle to the surface 12A of the cold-rolled steel sheet 12. Thus, the adhering substance adhered to the surface 12A of the cold-rolled steel sheet 12 is scraped off while polished, and removed by the rotating polishing brush 44B. The surface 12B of the cold-rolled steel sheet 12 is not polished because an adhering substance is not adhered to the surface 12B.

After the polishing step by the polishing device 40, the cold-rolled steel sheet 12 smoothed by removing the adhering substance from the surface 12A and the groove proceeds to the decarburization annealing step, which is a subsequent step,

### (Decarburization Annealing Step)

Next, in the decarburization annealing step, the decarburization annealing device 50 is used to perform decarburization annealing (continuous annealing) on the cold-rolled steel sheet 12 on which the groove is formed, at a predetermined temperature (for example, 700° C. to 900° C.). Thus, the cold-rolled steel sheet 12 is decarburized, and primary recrystallization (grain size: 10 μm to 30 μm) is generated in the cold-rolled steel sheet 12. Furthermore, as a result of decarburization annealing, an oxide layer mainly containing silica (SiO₂) is formed on the surfaces 12A and 12B of the cold-rolled steel sheet 12. The cold-rolled steel sheet 12 after formation of the oxide layer in the decarburization annealing step in the decarburization annealing device 50 proceeds to the annealing separator applying step, which is a subsequent step.

### (Annealing Separator Applying Step)

Next, in the annealing separator applying step, the annealing separator applying device 55 is used to apply an annealing separator mainly containing magnesia (MgO) onto the oxide layers formed during decarburization annealing on the surfaces 12A and 12B of the cold-rolled steel sheet 12. Then, the cold-rolled steel sheet 12 is wound into a coil shape by a winding device (not shown). The cold-rolled steel sheet 12 to which the annealing separator is applied by the annealing separator applying step in the annealing separator applying device 55 and which is wound by the winding device proceeds to the final annealing step, which is a subsequent step.

### (Final Annealing Step)

Next, as shown in FIG. 2, in the final annealing step, the coiled cold-rolled steel sheet 12 is annealed (batch annealed) using the final annealing device 60 at a predetermined temperature (for example, about 1200° C.) for a predetermined time (for example, about 20 hours). The heat treatment conditions are, for example, a heating temperature of 1100° C. to 1300° C. and a heating time of 20 hours to 24 hours.

Thus, secondary recrystallization is generated in the cold-rolled steel sheet 12 to generate a crystal orientation in which the magnetization easy axes are substantially aligned in the rolling direction, and a glass coating is formed on the surfaces 12A and 12B of the cold-rolled steel sheet 12. As a result, the grain-oriented electrical steel sheet 14 is formed. Then, the coiled grain-oriented electrical steel sheet 14 is unwound.

Here, the grain-oriented electrical steel sheet 14 contains, for example, an inhibitor such as MnS or AlN. Thus, in the final annealing step, crystal grains in the Goss orientation in which the magnetization easy axes are substantially aligned in the rolling direction preferentially grow into a crystal. As a result, the grain-oriented electrical steel sheet 14 having a high crystal orientation property (crystal orientation) is formed.

The grain-oriented electrical steel sheet 14 obtained by the final annealing step in the final annealing device 60 proceeds to the insulating coating agent applying step, which is a subsequent step.

### (Insulating Coating Agent Applying Step)

Next, in the insulating coating agent applying step, the insulating coating agent coating device 70 is used to apply an insulating coating agent (coating liquid) having electrical insulation properties and capable of applying a predetermined tension to the surfaces 14A and 14B of the grain-oriented electrical steel sheet 14 to the surfaces 14A and 14B of the grain-oriented electrical steel sheet 14.

### (Flattening Annealing Step)

Next, in the flattening annealing step, the flattening annealing device 80 is used to perform annealing (flattening annealing) at a predetermined temperature (for example, 800° C. to 850° C.) for a predetermined time (for example, 10 seconds or more and 120 seconds or less) while the conveyor conveys the grain-oriented electrical steel sheet 14 to which the insulating coating agent is applied.

At this time, a tension (sheet passing tension) along the rolling direction (longitudinal direction) of the grain-oriented electrical steel sheet 14 is applied to the grain-oriented electrical steel sheet 14 from the conveyor. Thus, the winding form and the strain of the grain-oriented electrical steel sheet 14 at the time of final annealing are removed to flatter the grain-oriented electrical steel sheet 14.

In the flattening annealing step, as a result of annealing of the grain-oriented electrical steel sheet 14, the surfaces 14A and 14B of the grain-oriented electrical steel sheet 14 are plated with the insulating coating agent, and the surfaces 14A and 14B of the grain-oriented electrical steel sheet 14 are coated with an insulating coating by the insulating coating agent. Then, the grain-oriented electrical steel sheet 14 is cooled.

### (Effect)

Next, an effect of the present embodiment will be described.

As shown in FIG. 1, according to the present embodiment, as described above, the oil adhered to the surface 12A of the cold-rolled steel sheet 12 is removed in the oil removal step, and then the surface 12A of the cold-rolled steel sheet 12 is irradiated with the laser beam L to form a groove in the laser irradiation step. Thus, in the present embodiment, inhibition due to the presence of the oil and the oil state such as the thickness is less likely to occur and thus the variation in the depth of the groove is more suppressed than in a case where the surface 12A of the cold-rolled steel sheet 12 to which the oil is adhered is irradiated with the laser beam L to form a groove.

When the surface 12A of the cold-rolled steel sheet 12 to which the oil is adhered is irradiated with the laser beam L, the heat of the laser beam L evaporates the oil, and the evaporated oil may adhere to and contaminate an optical system such as the laser irradiation device 30 (filter, objective lens, or the like). Meanwhile, according to the present embodiment, the oil adhered to the surface 12A of the cold-rolled steel sheet 12 is removed in the oil removal step in advance, and then the surface 12A is irradiated with the laser beam L to form a groove in the laser irradiation step, so that evaporation of the oil is completely absent or is suppressed. Therefore, contamination of an optical system such as the laser irradiation device 30 is suppressed. As a result, for example, cleaning or replacement of an optical component or the like included in the laser irradiation device 30 is unnecessary, or the frequency of the cleaning or replacement is reduced.

In the present embodiment, in the oil removal step before the laser irradiation step, the oil adhered to the surfaces 12A and 12B on both sides of the cold-rolled steel sheet 12 are removed by the cleaning brushes 22B of the pair of cleaning brush rolls 22. Thus, the oil adhered to the surfaces 12A and 12B on both sides of the cold-rolled steel sheet 12 can be efficiently removed.

In the present embodiment, in the laser irradiation step, a groove is formed on the surface 12A of the cold-rolled steel sheet 12, and then in the polishing step, an adhering substance adhered to the surface 12A of the cold-rolled steel sheet 12 is removed by the polishing brush 44B.

Here, while the surface 12A of the cold-rolled steel sheet 12 is irradiated with the laser beam L, a pass line variation may be caused by steel sheet vibration due to the accuracy of tension control or the shape of the steel sheet. As a result, an adhering substance such as a melt projection or a scattered substance may adhere to the surface 12A.

Therefore, in the present embodiment, such an adhering substance is removed by the polishing brush 44B of the polishing brush roll 44 in the polishing step. The polishing smooths the surface 12A of the cold-rolled steel sheet 12. Therefore, deterioration of the magnetic characteristics, such as the iron loss, of the grain-oriented electrical steel sheet 14 is suppressed. The building factor, which indicates the difference in the iron loss between before and after stacking the grain-oriented electrical steel sheets 14, is particularly improved.

In the present embodiment, a configuration is adopted in which even in a case where an adhering substance is adhered to the surface 12A of the cold-rolled steel sheet 12, the adhering substance can be removed. That is, in the polishing step, the adhering substance adhered to the surface 12A of the cold-rolled steel sheet 12 is removed by the polishing brush 44B of the polishing brush roll 44, and then in the decarburization annealing step, the cold-rolled steel sheet 12 is decarburization-annealed.

In the case of removing such an adhering substance, the removal is desirably performed at an appropriate removal timing. That is, as a result of decarburization annealing of the cold-rolled steel sheet 12, crystals in the cold-rolled steel sheet 12 are recrystallized (primary recrystallization), and an oxide film is formed on the surface 12A of the cold-rolled steel sheet 12. Therefore, the timing of removing the adhering substance is preferably such that the polishing step of removing the adhering substance adhered to the surface 12A of the cold-rolled steel sheet 12 by the polishing brush 44B of the polishing brush roll 44 is performed before the decarburization annealing step.

Thus, the oxide film formed on the surface 12A of the cold-rolled steel sheet 12 has a uniform film thickness as compared with a case where the adhering substance adhered to the surface 12A of the cold-rolled steel sheet 12 is not removed by the polishing brush 44B before the decarburization annealing step. Therefore, deterioration of the magnetic characteristics, such as the iron loss, of the grain-oriented electrical steel sheet 14 is suppressed.

### Modification Example

Next, a modification example of the above embodiment will be described.

In the above embodiment, the adhering substance on the surface 12A (on the side irradiated with the laser beam L) is polished by the polishing brush roll 44 while the surface 12B is supported by the backup roll 42. However, the present invention is not limited to this configuration. For example, in addition to the combination of the backup roll 42 and the polishing brush roll 44, another laser irradiation device 30 (not shown) may be provided on the surface 12B side. In this case, a configuration may be adopted in which a groove is formed also on the surface 12B by another laser irradiation device described above and the adhering substance on the surface 12B is polished by another polishing brush roll 44 while the surface 12A is supported by another backup roll 42.

In the above embodiment, the cleaning brush 22B is provided on the roll 22A of the cleaning brush roll 22. However, for the cleaning brush 22B, for example, a slider that reciprocates in the width direction of the cold-rolled steel sheet 12 (not shown) may be used without being limited to the roll 22A. A configuration may be adopted in which the oil is removed with a chemical liquid or the like without using the cleaning brush roll 22 or the slider.

In the above embodiment, the oil removal device 20 includes the cleaning brush 22B. However, for the oil removal device 20, for example, a cleaning tank in which a cleaning liquid is stored (not shown) may be adopted instead without being limited to the cleaning brush 22B. In this case, the cold-rolled steel sheet 12 is passed so as to be immersed in the cleaning liquid stored in the cleaning tank, and thus the oil adhered to the surfaces 12A and 12B on both sides of the cold-rolled steel sheet 12 can be removed.

As the cleaning tank, a tank such as an ultrasonic cleaning tank can be adopted in which oil can be effectively removed by immersing the cold-rolled steel sheet 12.

In the above embodiment, the polishing brush 44B is provided on the roll 44A of the polishing brush roll 44. However, for the polishing brush 44B, for example, a slider that reciprocates in the width direction of the cold-rolled steel sheet 12 (not shown) may be used without being limited to the roll 44A.

In the above embodiment, a case is exemplified in which the polishing device 40 includes the polishing brush 44B. However, for the polishing device 40, for example, a grindstone may be used instead without being limited to the polishing brush 44B.

In the above embodiment, the manufacturing apparatus 10 is provided with the finish rolling mill 15, the polishing device 40, the decarburization annealing device 50, the annealing separator applying device 55, the final annealing device 60, the insulating coating agent coating device 70, and the flattening annealing device 80. However, among them, the finish rolling mill 15, the polishing device 40, the decarburization annealing device 50, the annealing separator applying device 55, the final annealing device 60, the insulating coating agent coating device 70, and the flattening annealing device 80 are to be provided for the manufacturing apparatus 10 as necessary, and can be omitted as appropriate.

### (Comparative Test)

Next, a comparative test will be described.

In this comparative test, grain-oriented electrical steel sheets were manufactured with manufacturing methods according to an invention example and a comparative example, and the variations in depth of grooves formed in the grain-oriented electrical steel sheets and the iron loss improvement percentages of the grain-oriented electrical steel sheets were compared and examined.

In the manufacturing method according to the invention example, the oil removal step was performed after the cold rolling step and before the laser irradiation step, in the same manner as in the manufacturing method according to the above embodiment. In addition, the polishing step was performed after the laser irradiation step and before the decarburization annealing step.

Meanwhile, the manufacturing method according to the comparative example was different from the invention example in that the oil removal step was not performed after the cold rolling step and before the laser irradiation step. That is, the manufacturing method according to the comparative example was different from the manufacturing method according to the above embodiment.

### (Processing Conditions of Laser Groove)

In the laser irradiation step according to the invention example and the comparative example, the processing conditions of the grooves (laser grooves) formed on the surface of the grain-oriented electrical steel sheet were as follows.
Power of laser beam: 2000 [W]
Speed of scanning by laser beam (scanning speed): 45 [m/s]
Pitch (interval) between grooves: 3 [mm]
Shape of laser beam: 25 [μm]×50 [μm]

The depth of each groove was measured with a measuring device (KEYENCE (registered trademark) WI-5000, WI-001). The specific groove depth can be obtained by measuring the length corresponding to the difference (HO-H) between HO (>0) representing the average height measured in an arbitrary range without a groove on the surface of the steel sheet and H (>0) representing the height at the maximum depth of the groove part, using the above device.

### (Results of Groove Depth)

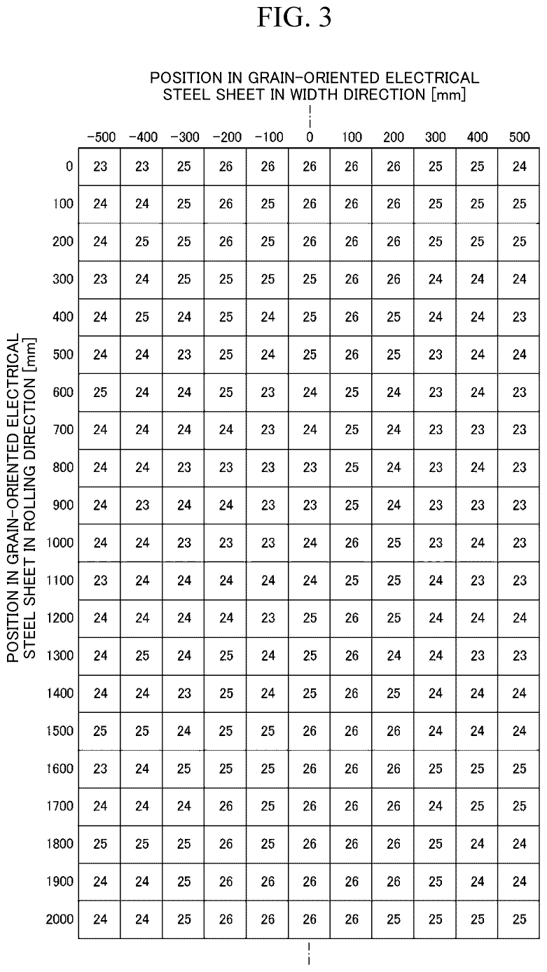

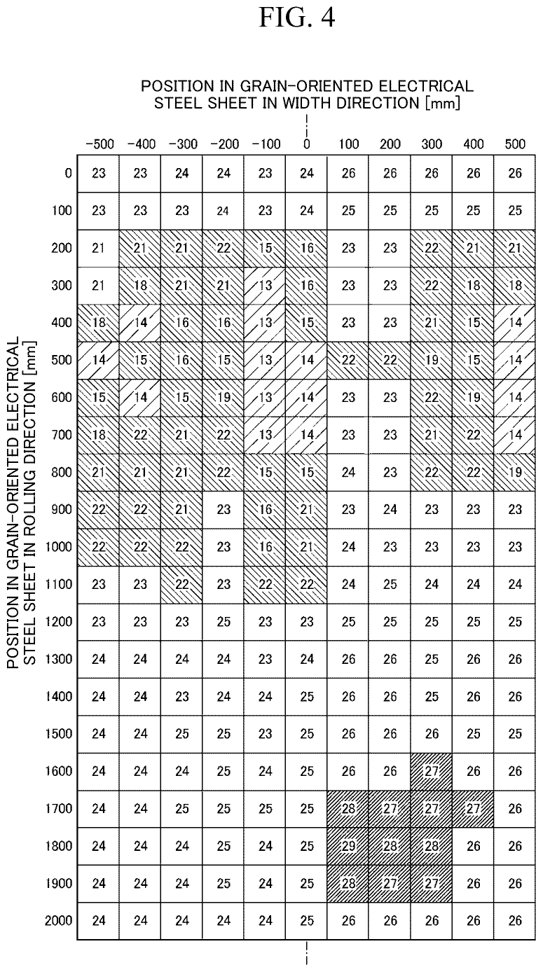

FIG. 3 shows the depths of the grooves on the grain-oriented electrical steel sheet manufactured with the manufacturing method according the invention example. FIG. 4 shows the depths of the grooves on the grain-oriented electrical steel sheet manufactured with the manufacturing method according the comparative example.

The vertical axis [mm] in each of the tables shown in FIGS. 3 and 4 indicates the position in the grain-oriented electrical steel sheet in the rolling direction (longitudinal direction). The horizontal axis [mm] in each of the tables shown in FIGS. 3 and 4 indicates the position in the grain-oriented electrical steel sheet in the width direction. Each grid in the tables shown in FIGS. 3 and 4 shows the depth [μm] of the groove closest to the predetermined position specified by the position on the vertical axis and the position on the horizontal axis in the grain-oriented electrical steel sheet.

The following Table 1 shows the average value and the variation (standard deviation) o of the depths of the grooves in the grain-oriented electrical steel sheet manufactured with the manufacturing method according to each of the invention example and the comparative example.

TABLE 1

| | Groove depth [μm] | |
|---|---|---|
| | Average value | Variation (standard deviation) σ |
| Invention example | 24.5 | 1.0 |
| Comparative example | 22.5 | 3.7 |

As shown in Table 1, in the manufacturing method according to the comparative example, the average value of the groove depths was 22.5 [μm]. In the manufacturing method according to the invention example, the average value of the groove depths was 24.5 [μm], and thus was deeper than that in the manufacturing method according to the comparative example.

As shown in Table 1, in the manufacturing method according to the comparative example, the variation (standard deviation) o of the groove depths was 3.7. In the manufacturing method according to the invention example, the variation (standard deviation) o of the groove depths was 1.0, and thus was smaller than that in the manufacturing method according to the comparative example.

From the results, it has been found that in the manufacturing method according to the invention example, the efficiency of forming grooves was higher and the variation o in groove depth was lower than in the manufacturing method according to the comparative example.

### (Results of Iron Loss Improvement Percentage)

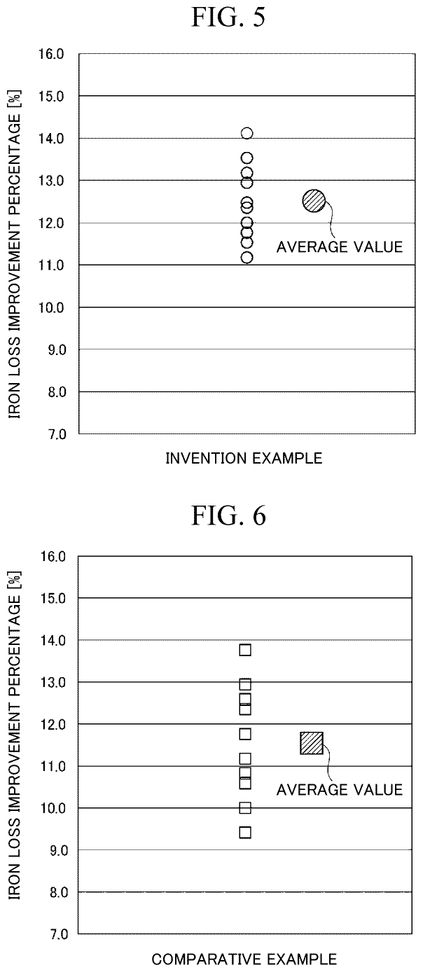

FIG. 5 shows the iron loss improvement percentages [%] and the average value of the iron loss improvement percentages [%] of a plurality of grain-oriented electrical steel sheets manufactured with the manufacturing method according to the invention example. FIG. 6 shows the iron loss improvement percentages [%] and the average value of the iron loss improvement percentages [%] of a plurality of grain-oriented electrical steel sheets manufactured with the manufacturing method according to the comparative example.

The iron loss improvement percentages of the grain-oriented electrical steel sheets according to the invention example and the comparative example were obtained from the following formula (1) based on the iron loss of the material steel sheet.

$$Iron loss improvement percentage [ \% ] = ( ( iron loss of material steel sheet - iron loss of grain - oriented electrical steel sheet according to invention example or comparative example ) \text{} / iron loss of material steel sheet ) \times 100 \qquad Formula ( 1 )$$

Here, the method of manufacturing a material steel sheet was different from the manufacturing method according to the above embodiment in that the oil removal step, the laser irradiation step, and the polishing step were not performed. That is, no groove was formed in the material steel sheet.

The iron loss [W/kg] of each of the material steel sheets and the grain-oriented electrical steel sheets according to the invention example and the comparative example was the iron loss when a magnetic field of a maximum magnetic flux density of 1.7 Tesla and 50 Hz was applied to the following 10 test pieces, and was measured with a single sheet tester (SST). The iron loss of each material steel sheet was 0.85 [W/kg].

### <Test Piece>

Dimensions of test piece: 60 [mm]×300 [mm]
Sheet thickness of test piece: 0.23 [mm]

The following Table 2 shows the iron loss improvement percentage and the variation (standard deviation) o in iron loss improvement percentage of the grain-oriented electrical steel sheets manufactured with the manufacturing method according to each of the invention example and the comparative example.

TABLE 2

| | Iron loss improvement percentage [%] | |
|---|---|---|
| | Average value | Variation (standard deviation) σ |
| Invention example | 12.5 | 0.9 |
| Comparative example | 11.5 | 1.3 |

As shown in Table 2, in the manufacturing method according to the comparative example, the average value of the iron loss improvement percentage was 11.5 [%]. In the manufacturing method according to the invention example, the average value of the iron loss improvement percentage was 12.5 [%], and thus was higher than that in the manufacturing method according to the comparative example.

As shown in Table 2, in the manufacturing method according to the comparative example, the variation o of the iron loss improvement percentage was 1.3. In the manufacturing method according to the invention example, the variation o of the iron loss improvement percentage was 0.9, and thus was smaller than that in the manufacturing method according to the comparative example.

From this, it has been found that in the manufacturing method according to the invention example, the iron loss improvement percentage was higher and the variation o in iron loss improvement percentage was lower than in the manufacturing method according to the comparative example.

(Relationship between Thickness of Oil and Depth of Groove)

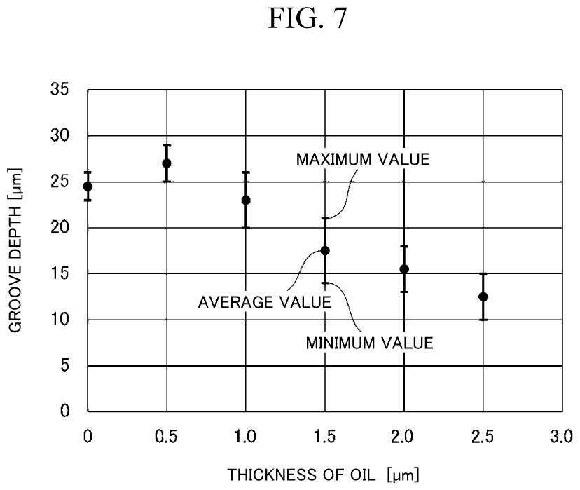

Next, FIG. 7 shows a graph showing a relationship between the thickness of an oil adhered to the surface of the cold-rolled steel sheet and the depth of a groove formed on the surface of the cold-rolled steel sheet by the laser beam.

FIG. 7 shows the minimum value, the maximum value, and the average value of the groove depths for the thickness of each oil. The thickness of the oil adhered to the cold-rolled steel sheet on the surface was measured with a measuring device (KEYENCE (registered trademark) VK-X3000).

As shown in FIG. 7, in a range of the thickness of the oil adhered to the surface of the cold-rolled steel sheet of 0.5 [μm] to 2.5 [μm], the depth of the groove formed on the surface of the cold-rolled steel sheet by the laser beam was deeper as the thickness of the oil was thinner. This is considered to be because the laser beam more easily reached the surface of the cold-rolled steel sheet as the thickness of the oil was thinner.

Next, in a case where the thickness of the oil on the surface of the cold-rolled steel sheet was 0 [μm], the average value of the groove depths was shallower than in the case of a thickness of the oil of 0.5 [μm]. However, in a case where the thickness of the oil on the surface of the cold-rolled steel sheet was 0 [μm], the difference between the minimum value and the maximum value of the groove depths, that is, the variation in groove depth was smaller than in the case of a thickness of the oil of 0.5 [μm]. From this, it can be seen that the variation in depth of the grooves formed on the surface of the cold-rolled steel sheet was reduced by removing the oil adhered to the surface of the cold-rolled steel sheet.

Although an embodiment of the present invention is described above, the present invention is not limited to the above embodiment. The above embodiment and various modification examples may be appropriately combined and used, and various modifications may be appropriately added without departing from the gist of the present invention.

### INDUSTRIAL APPLICABILITY

According to each of the above aspects of the present invention, it is possible to provide a method for manufacturing a grain-oriented electrical steel sheet and a manufacturing apparatus of a grain-oriented electrical steel sheet that can reduce a variation in groove depth in high order without requiring extensive control. In addition, according to each of the above aspects, it is also possible to reduce the frequency of cleaning or replacement of an optical component or the like due to contamination. Therefore, the industrial applicability is significant.

### REFERENCE SIGNS LIST

10 Manufacturing apparatus
12 Cold-rolled steel sheet
12A Surface
12B Surface
15 Finish rolling mill
20 Oil removal device
22B Cleaning brush
30 Laser irradiation device
40 Polishing device
44B Polishing brush
50 Decarburization annealing device
55 Annealing separator applying device
60 Final annealing device
70 Insulating coating agent coating device
80 Flattening annealing device

1. A method for manufacturing a grain-oriented electrical steel sheet, the method comprising:
an oil removal step of removing an oil adhered to a surface of a cold-rolled steel sheet during rolling;
a laser irradiation step of irradiating the surface of the cold-rolled steel sheet from which the oil is removed, with a laser beam to form a groove after the oil removal step; and
a decarburization annealing step of decarburization-annealing the cold-rolled steel sheet on which the groove is formed, after the laser irradiation step.

2. The method for manufacturing a grain-oriented electrical steel sheet according to claim 1, further comprising
a polishing step of removing an adhering substance adhered to the surface of the cold-rolled steel sheet on which the groove is formed, by polishing after the laser irradiation step and before the decarburization annealing step.

3. The method for manufacturing a grain-oriented electrical steel sheet according to claim 1, wherein in the oil removal step, the oil adhered to the surface of the cold-rolled steel sheet is removed using an oil removal device including a cleaning brush.

4. A manufacturing apparatus of a grain-oriented electrical steel sheet, the manufacturing apparatus comprising:
an oil removal device configured to remove an oil adhered to a surface of a cold-rolled steel sheet during rolling;
a laser irradiation device configured to irradiate the surface of the cold-rolled steel sheet from which the oil is removed, with a laser beam to form a groove; and
a decarburization annealing device configured to decarburization-anneal the cold-rolled steel sheet on which the groove is formed.

5. The manufacturing apparatus of a grain-oriented electrical steel sheet according to claim 4, further comprising
a polishing device configured to remove an adhering substance adhered to the surface of the cold-rolled steel sheet on which the groove is formed, by polishing before decarburization annealing by the decarburization annealing device.

6. The manufacturing apparatus of a grain-oriented electrical steel sheet according to claim 4, wherein the oil removal device includes a cleaning brush configured to remove the oil adhered to the surface of the cold-rolled steel sheet.
